(19) United States
(12) Patent Application Publication
(10) Pub. No.: US 2009/0164096 A1
(43) Pub. Date: Jun. 25, 2009

(54) METHOD OF CONTROLLING AN AIR SUPPLY OF AN INTERNAL COMBUSTION ENGINE

(76) Inventors: Friedrich Graf, Sinzing (DE); Achim Przymusinski, Lappersdorf (DE); Björn Schelinsky, Douausfauf (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/300,504

(22) PCT Filed: May 14, 2007
(86) PCT No.: PCT/EP07/54627

§ 371 Date: Nov. 12, 2008

(30) Foreign Application Priority Data
May 18, 2006 (DE) 10 2006 023 469.3

(51) Int. Cl. F02D 43/00

(52) U.S. Cl. 701/103; 60/606

(57) ABSTRACT

In a control method for an air supply of an internal combustion engine having a turbocharger, track data are evaluated, future power increase points of the internal combustion engine are detected and initialization of the increased power output of the internal combustion engine is realized.

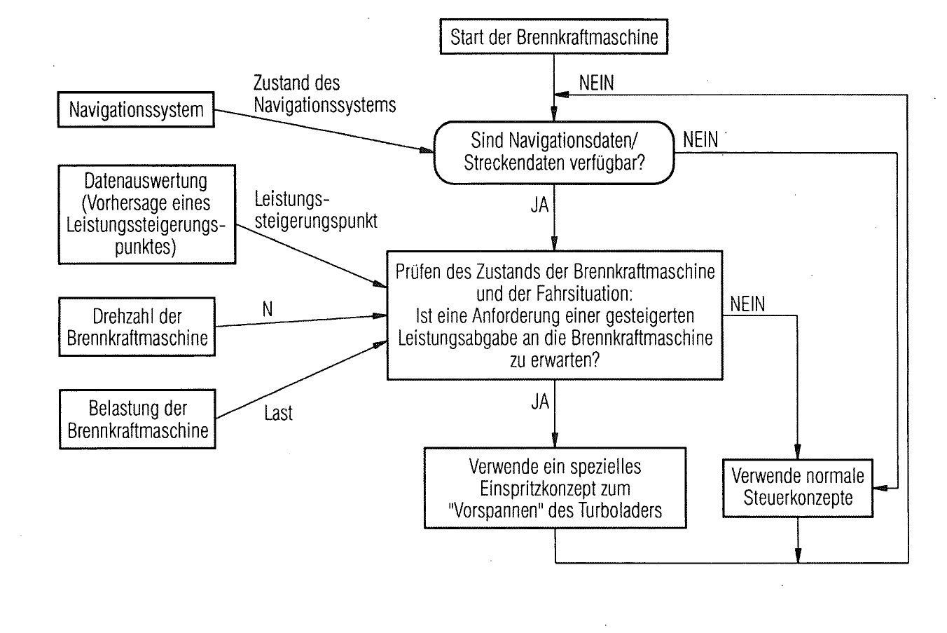

### CROSS-REFERENCE TO RELATED APPLICATIONS

This application is a U.S. National Stage Application of International Application No. PCT/EP2007/054627 filed May 14, 2007, which designates the United States of America, and claims priority to German Application No. 10 2006 023 469.3 filed May 18, 2006, the contents of which are hereby incorporated by reference in their entirety.

### TECHNICAL FIELD

The present invention relates to a method of controlling an air supply of an internal combustion engine in a motor vehicle, in particular a control method for a diesel engine with turbocharger.

### BACKGROUND

In modern internal combustion engines the generated power is substantially determined by the injected quantity of fuel, the prevailing fuel pressure and by the quantity and pressure of supplied air. Greater delays, which have a physical cause, occur in the regulation of the air supply compared with regulation of the fuel pressure. This affects for example the supplied quantity of air and the pressure of the supplied air. Since the requested quantity of air is only delivered once vehicle-specific idle times have elapsed therefore, the acceleration behavior of the vehicle is negatively affected thereby.

In a motor vehicle with a turbocharger the cause of this behavior lies in the mode of operation of the turbocharger. The turbocharger is usually mechanically coupled to the exhaust of the internal combustion engine. The power of the turbocharger, for example the magnitude of the generated charge air pressure, therefore depends directly on the exhaust gases transported in the exhaust. If for example the internal combustion engine only generates a low quantity of exhaust gases and/or exhaust gases with a low temperature, and this is the case with low speeds and low engine load of the internal combustion engine, the charge air pressure that can be generated by the turbocharger is comparatively low. If a sudden increase in power of the internal combustion engine is requested the turbocharger requires a certain amount of time to generate an adequate boosting charge air pressure. This state of briefly absent boosting of the internal combustion engine by a turbocharger is generally known as a “turbo lag”.

Two approaches are known in the prior art to overcome or at least limit the above drawbacks. One approach consists in using an electrically operated or electrically assisted turbocharger. However this solution has the drawback that compared with a normal turbocharger it is associated with higher hardware costs and higher electrical power consumption. For these reasons this approach is not suitable for use in large-volume production of motor vehicles. It has previously only been used in prototypes to promote further development.

The second approach consists in the use of a two-stage turbocharger system which is also called a twin turbo or register charging. Tests on such systems demonstrate the potential for air path optimization using two-stage turbocharger systems. For example in an Opel study the power of a common rail diesel engine with 1.9 l displacement was increased from 110 kW to 156 kW using two-stage turbocharger technology. However there is a considerable drawback with respect to two-stage turbocharger systems in that compared with standard turbochargers they are associated with considerably higher hardware costs for implementation of such an air path.

### SUMMARY

A less expensive, optimized air supply for an internal combustion engine can be provided compared with the prior art.

According to an embodiment, a method of controlling an air supply of an internal combustion engine in a motor vehicle, in particular a diesel engine with turbocharger, may comprise the following steps: a) transferring track data of a track that is to be covered by the motor vehicle to a motor control unit, b) detecting at least one future power increase point of the internal combustion engine using the track data, at which point a request for increased power output of the internal combustion engine should be expected, and c) preparing the increased power output, so the internal combustion engine can for a short time be brought into a state of increased power output, by injecting and igniting a torque-neutral post-injection, so an exhaust gas temperature of the internal combustion engine is increased and a turbocharger of the internal combustion engine is pre-loaded.

### BRIEF DESCRIPTION OF THE DRAWINGS

Preferred embodiments of the present invention will be described in more detail with reference to the accompanying drawing. The FIGURE shows a flow diagram of an embodiment of the control method.

### DETAILED DESCRIPTION

The control method according to an embodiment is particularly suitable for motor vehicles with a diesel engine and turbocharger. It comprises the following steps: a) transferring track data of a track that is to be covered by the motor vehicle to a motor control unit, b) detecting at least one future power increase point of the internal combustion engine using the track data, at which point a request for increased power output of the internal combustion engine should be expected, and c) preparing the increased power output, so the internal combustion engine can for a short time be brought into a state of increased power output.

To optimize the air supply of an internal combustion engine the motor control unit of the internal combustion engine or motor vehicle is firstly supplied with data about the track to be covered. This takes place for example via a navigation system or manual input of track data, which data is then passed to the motor control unit. Using the evaluation of such data as a basis the motor control unit can discern at which points of the routing the driver of the motor vehicle could request an increased power output from the internal combustion engine. To keep the idle times through to power provision or delay between power request and power implementation by the internal combustion engine as low as possible for these power increase points the internal combustion engine is purposefully put into a state of readiness for the expected increase in power.

According to one embodiment this state of readiness is generated in an internal combustion engine with turbocharger by injecting and igniting a torque-neutral injection, so an exhaust gas temperature of the internal combustion engine is increased and the turbocharger of the internal combustion engine is preloaded. The preloaded turbocharger minimizes the turbo lag known from the prior art which in the case of a sudden request for a power increase in the internal combustion engine leads to delay times in the power output of the internal combustion engine.

One embodiment of the control method is constructed in such a way that it may be implemented with standard components of an air path of the internal combustion engine. These standard components include for example a simple turbocharger without additional electrical systems. Optimization of the power output of the internal combustion engine can be achieved according to an embodiment solely by measures inside the engine therefore. This simultaneously ensures that no increased hardware costs are required to implement the various embodiments. In addition thereto however it is also conceivable to conduct the present control method with an electrically assisted turbocharger or a two-stage turbocharger system.

The idea underlying the various embodiments lies in the predictive influencing of the exhaust gas properties to reduce the turbo lag. By evaluating track data, which is provided for example via a connected navigation system, manual input of track data or some other form of recording this track data, future power increase points of the internal combustion engine may therefore be predicted with a high degree of probability. Power increase points denote points at which a request for an increased power output of the internal combustion engine should be expected, for example owing to the routing or the driving behavior of a driver. Such power increase points are inter alia the approach to a freeway or motorway, leaving a bend or a mountain pass or similar situations.

In modern internal combustion engines with multiple injection a torque-neutral, late post-injection and ignition of this injected quantity is carried out to prepare for an increased power output of the internal combustion engine. Using this post-injection the exhaust gas temperature is increased compared with the state without post-injection, so the turbocharger of the internal combustion engine provides the internal combustion engine with air with a higher compression ratio. The turbocharger is therefore in a “preloaded” state which ensures an immediate power increase of the internal combustion engine with minimized turbo lag.

The clear reduction in turbo lag primarily leads to improved performance of the motor vehicle and to increased traveling comfort owing to the improved response characteristic of the internal combustion engine. Secondary thereto are also lower internal combustion engine emissions during the acceleration phase. These advantages are achieved solely by control-engineering optimizations and without additional hardware costs.

An embodiment will be described in more detail with reference to the accompanying drawing. The control method is stored for example in a motor control unit of the internal combustion engine, carries out its data evaluation therein and transmits commands to connected components.

At the start of the control method it is first of all queried in step S1 whether navigation or track data is available for the motor vehicle track to be covered. According to an alternative this track data is provided by a connected navigation system. The motor control unit thus firstly checks whether the navigation system is switched on and/or is connected so as to be working in order to integrate it in the continuing course of the control method in the event of a positive response. If there is no navigation system available it is also conceivable to manually input track data or to retrieve it from a memory in which it is stored.

The use of normal control concepts is instructed in step S2 if no navigation or track data is available. If the navigation system is switched off or defective for example the motor control unit would therefore leave the control method as early as at this point. However it would query constantly or at regular intervals the availability of navigation and/or track data in order to re-start the control method (step S0).

Step S3 follows if the engine control unit were to be informed that a navigation system is connected and working. Track data is passed to a data evaluation by the navigation system after the driver of the motor vehicle has input a destination. The data evaluation checks the received track data for whether one or more power increase point(s) of the internal combustion engine are found in the course of this track. These power increase points identify track points at which it is anticipated that the driver of the motor vehicle will request an increased power output of the internal combustion engine.

As soon as these power increase points have been determined they are passed to the engine control unit. At the same time the engine control unit receives information constantly or at regular intervals about the state of the internal combustion engine. This information includes for example the speed of the internal combustion engine and the loading or output torque of the internal engine.

The engine control unit checks the state of the internal combustion engine using the data provided. According to one embodiment this includes checking the state of the turbocharger and its ability to boost an increased power output of the internal combustion engine as quickly as possible. The engine control unit also checks as a function of the instantaneous position of the motor vehicle on the stipulated track whether a power increase point is about to be reached. Step 4 follows if for example the power increase point is imminent and the turbocharger is not in a “preloaded” state.

A special injection concept is now introduced on the basis of checking of the internal combustion engine in order to preload the turbocharger. The special injection concept is purposefully started at a time so the turbocharger is put into its preloaded state before a possible power increase point is reached. This ensures that the turbocharger boosts a requested increased power output of the internal combustion engine without turbo lag or with minimized turbo lag.

Step S2 follows if checking of the status data of the internal combustion engine and the instantaneous position of the motor vehicle demonstrate that no power increase point is expected. The consequence of this is that the internal combustion engine is controlled using normal control concepts.

Once the power increase point has been passed with or without a request for an increased power output of the internal combustion engine, the control method returns to the start to again prepare for power increase points on the motor vehicle's planned track possibly being reached.

What is claimed is:

1. A method of controlling an air supply of an internal combustion engine in a motor vehicle comprising the following steps:
transferring track data of a track that is to be covered by the motor vehicle to a motor control unit,
detecting at least one future power increase point of the internal combustion engine using the track data, at which point a request for increased power output of the internal combustion engine should be expected, and
preparing the increased power output, so the internal combustion engine can for a short time be brought into a state of increased power output, by injecting and igniting a torque-neutral post-injection, so an exhaust gas temperature of the internal combustion engine is increased and a turbocharger of the internal combustion engine is pre-loaded.

2. The method according to claim 1, wherein the internal combustion engine is a diesel engine with turbocharger.

3. The method according to claim 1, wherein the track data is supplied by a navigation system.

4. The method according to claim 1, wherein the track data is supplied by manual input of track data.

5. The method according to claim 1, wherein the power increase points are determined according to the routing or the driving behavior of a driver.

6. The method according to claim 1, wherein the power increase points selected from the group consisting of: the approach to a freeway, the approach to a motorway, leaving a bend, and leaving a mountain pass.

7. The method according to claim 1, wherein the control method is stored in a motor control unit of the internal combustion engine.

8. The method according to claim 1, wherein the turbocharger is an electrically assisted turbocharger.

9. The method according to claim 1, wherein the turbocharger is a two-stage turbocharger system.

10. An internal combustion engine in a motor vehicle comprising:
a motor control unit receiving track data of a track that is to be covered by the motor vehicle,
wherein the motor control unit is operable to detect at least one future power increase point of the internal combustion engine using the track data, at which point a request for increased power output of the internal combustion engine should be expected, and
means for injecting and igniting a torque-neutral post-injection to prepare the increased power output, so the internal combustion engine can for a short time be brought into a state of increased power output, wherein an exhaust gas temperature of the internal combustion engine is increased and a turbocharger of the internal combustion engine is pre-loaded.

11. The internal combustion engine according to claim 10, wherein the internal combustion engine is a diesel engine with turbocharger.

12. The internal combustion engine according to claim 10, wherein the track data is supplied by a navigation system.

13. The internal combustion engine according to claim 10, wherein the track data is supplied by manual input of track data.

14. The internal combustion engine according to claim 10, wherein the power increase points are determined according to the routing or the driving behavior of a driver.

15. The internal combustion engine according to claim 10, wherein the power increase points selected from the group consisting of: the approach to a freeway, the approach to a motorway, leaving a bend, and leaving a mountain pass.

16. The internal combustion engine according to claim 10, wherein the turbocharger is an electrically assisted turbocharger.

17. The internal combustion engine according to claim 10, wherein the turbocharger is a two-stage turbocharger system.
